(19) United States
(12) Patent Application Publication
(10) Pub. No.: US 2026/0157575 A1
(43) Pub. Date: Jun. 11, 2026

(54) Automated Cooking Device and Automated Cooking Method

(71) Applicant: TECHMAGIC INC., Tokyo (JP)

(72) Inventor: Yuichi KUMAKURA, Tokyo (JP)

(21) Appl. No.: 19/179,344

(22) Filed: Apr. 15, 2025

(30) Foreign Application Priority Data
Apr. 16, 2024 (JP) 2024-066432

(51) Int. Cl. A47J 44/00; A47J 27/14; A47J 36/32

(52) U.S. Cl. CPC A47J 44/00; A47J 36/32; A47J 27/14

(57) ABSTRACT

[Problem] To provide an automated cooking device in which a pivot position when a stir member detachably attached to a container body rotates is detected.

[Solution] An automated cooking device 10 comprising: a cooking container 300 including a bottomed cylindrical container body 310 configured to contain an ingredient I and a stir member 320 detachably attached to the container body 310 and configured to rotate independently of the container body 310; a container holding unit 200 configured to allow the stir member 320 of the cooking container 300 to rotate, while holding the cooking container 300; and a control unit 800 configured to control driving of the container holding unit 200, the automated cooking device 10 being configured to stir and cook the ingredient I contained in the container body 310 using the stir member 320, in which the automated cooking device 10 has a mechanism for detecting a pivot position of the stir member 320, the mechanism including a detection object 323 provided to the stir member 320 and a detector 730 arranged in the exterior of the cooking container 300 and configured to detect the detection object 323.

### TECHNICAL FIELD

The present invention relates to an automated cooking device and an automated cooking method, and particularly to an automated cooking device and an automated cooking method in which an ingredient contained in a cooking container including a container body configured to contain an ingredient and a stir member detachably attached to the container body and configured to rotate independently of the container body is stirred and cooked.

### BACKGROUND ART

In recent years, in the food industry, automation of cooking operations has been more and more developed in view of circumstances, such as securing cooks, maintaining cooking skills, and improving cooking environments.

In this regard, there has been hitherto known an automated cooking device comprising: a container holding unit configured to hold a bottomed cylindrical cooking container; a pivot unit configured to allow the cooking container held by the container holding unit to pivot such that the cooking container can rise and fall between a front area and a back area of a cooking counter; and a control unit configured to control driving of the container holding unit and the pivot unit, the automated cooking device being configured to at least stir and cook an ingredient contained in the cooking container, in which the cooking container includes a stir member provided on an inner bottom surface or an inner side surface of a container body in such a manner as to protrude toward an interior space of the container body (for example, see Patent Literature 1).

### PRIOR ART DOCUMENT

### Patent Literature

Patent Literature 1: JP 2022-175791A

### SUMMARY OF INVENTION

### Technical Problem

However, in the above-mentioned automated cooking device, the stir member rotates integrally with the container body of the cooking container, so that depending upon a pivot stop position of the stir member when stirring and cooking is finished, the stir member may block food in the container body, making it difficult for a person who plates up the food to take out the food from the container body.

On the other hand, when the stir member is configured to be detachable from the container body in order to realize trained skills of a stir operation by a cook in a more natural and advanced manner, in comparison with the automated cooking device provided with the cooking container in which the container body and the stir member rotate integrally as described above, the automated cooking device is not capable of detecting a pivot stop position of the stir member from a pivot stop position of the container body, making it even more difficult for the automated cooking device to determine a pivot position of the stir member.

Thus, the present invention is to solve the problem of the prior art as described above. In other words, it is an object of the present invention to provide an automated cooking device and an automated cooking method in which a pivot position when a stir member detachably attached to a container body and configured to rotate independently of the container body rotates is determined.

### Solution to Problem

The invention according to claim 1 is to solve the above problem by an automated cooking device comprising: a cooking container including a bottomed cylindrical container body configured to contain an ingredient and a stir member detachably attached to the container body and configured to rotate independently of the container body; a container holding unit configured to allow the stir member of the cooking container to rotate, while holding the cooking container; and a control unit configured to control driving of the container holding unit, the automated cooking device being configured to stir and cook the ingredient contained in the cooking body using the stir member, in which the automated cooking device has a mechanism for detecting a pivot position of the stir member, the mechanism including a detection object provided to the stir member and a detector arranged in the exterior of the cooking container and configured to detect the detection object.

The invention according to claim 2 is to further solve the above problem by, in addition to the features of the automated cooking device according to claim 1, the features in which the detection object has a magnet, and the detector is a magnetic sensor.

The invention according to claim 3 is to further solve the above problem by, in addition to the features of the automated cooking device according to claim 1, the features in which the container holding unit can cause the cooking container to rise and fall in a front and back direction of a cooking counter on which the container holding unit is placed, and the detector is located outside of a range of the cooking container passing when the cooking container is caused to rise and fall in the front and back direction of the cooking counter.

The invention according to claim 4 is to further solve the above problem by, in addition to the features of the automated cooking device according to claim 1, the features in which the stir member has an inner surface facing the container body and an outer surface on a side opposite to the inner surface, and the detection object is disposed on the outer surface of the stir member.

The invention according to claim 5 is to further solve the above problem by, in addition to the features of the automated cooking device according to claim 1, the features in which the container holding unit can cause the cooking container to rise and fall in a front and back direction of a cooking counter on which the container holding unit is placed, the detection object is provided near a tip of the stir member, and the control unit is configured to control driving of the container holding unit such that in a plating assist posture in which the cooking container is tilted forward, the tip of the stir member is located at a retreat position farthest from a plate placed on the cooking counter.

The invention according to claim 6 of is to solve the above problem by an automated cooking method using an automated cooking device, the automated cooking device comprising: a cooking container including a bottomed cylindrical container body configured to contain an ingredient and a stir member detachably attached to the container body and configured to rotate independently of the container body; a container holding unit capable of causing the cooking container to rise and fall in a front and back direction of a cooking counter and configured to allow the stir member of the cooking container to rotate, while holding the cooking container; a control unit configured to control driving of the container holding unit; and a mechanism for detecting a pivot position of the stir member, the mechanism including a detection object provided near a tip of the stir member and a detector arranged in the exterior of the cooking container and configured to detect the detection object, the automated cooking method comprising: a pivot position determining step in which the control unit determines a pivot position of the stir member; a stirring cooking step in which in a cooking posture in which the cooking container is tilted backward, the stir member of the cooking container is allowed to rotate to stir and cook the ingredient contained in the container body; and a plating assist step in which after completion of the stirring cooking step, the cooking container is tilted forward to a plating assist posture, in which the stir member is configured such that in the plating assist posture, the tip of the stir member is at a retreat position farthest from a plate placed on the cooking counter.

### Effects of Invention

According to the automated cooking device of the invention according to claim 1, the automated cooking device has a mechanism for detecting a pivot position of the stir member, the mechanism including a detection object provided to the stir member and a detector arranged in the exterior of the cooking container and configured to detect the detection object, so that the detector detects the detection object passing the detector, whereby the control unit determines a pivot position of the stir member, and thus, regardless of a configuration of engagement between the stir member and the container holding unit, it is possible to determine a pivot position when the stir member detachably attached to the container body and configured to rotate independently of the container body rotates relative to the container body, which allows the stir member to be automatically retreated to such an optimal retreat position as not to interfere with plating or washing when a person who plates up food after completion of cooking plates up food from the cooking container or when the cooking container is automatically washed.

According to the automated cooking device of the invention according to claim 2, in addition to the effects produced by the automated cooking device of the invention according to claim 1, the detection object has a magnet, and the detector is a magnetic sensor, so that the control unit determines a pivot position of the stir member on the basis of a change in the magnetic field around the detector. Thus, in comparison with a case in which the detector optically detects the detection object, not only the control unit can reliably determine a pivot position of the stir member even if the detector or the detection object is stained with a dirt due to cooking, such as a greasy dirt, but also there is no influence on a person who carries out a cooking assist operation or the like around the automated cooking device. In addition, in comparison with a case in which the detector is a proximity sensor configured to detect the detection object on the basis of an eddy current, a detection performance can be ensured even if a relative distance between the detector and the stir member is large, so that the degree of freedom of a device design of the automated cooking device can be improved.

According to the automated cooking device of the invention according to claim 3, in addition to the effects produced by the automated cooking device of the invention according to claim 1, the detector is located outside of a range of the cooking container passing when the cooking container is caused to rise and fall in the front and back direction of the cooking counter, so that the cooking container does not interfere with the detector even if the container holding unit allows the cooking container to rise and fall in the front and back direction. Consequently, the container holding unit allows the cooking container to rise and fall in the front and back direction such that various postures can be easily assumed.

According to the automated cooking device of the invention according to claim 4, in addition to the effects produced by the automated cooking device of the invention according to claim 1, the detection object is disposed on the outer surface of the stir member, so that the ingredient, seasonings or the like are less likely to adhere to the detection object when the automated cooking device stirs and cooks the ingredient, and thus it is possible to prevent the detection object from being stained with the ingredient, etc.

According to the automated cooking device of the invention according to claim 5, in addition to the effects produced by the automated cooking device of the invention according to claim 1, the container holding unit can cause the cooking container to rise and fall in a front and back direction of a cooking counter on which the container holding unit is placed, the detection object is provided near a tip of the stir member, and the control unit is configured to control driving of the container holding unit such that in a plating assist posture in which the cooking container is tilted forward, the tip of the stir member is located at a retreat position farthest from a plate placed on the cooking counter, so that in the plating assist posture, the tip of the stir member is located upward, which can make it easier for a person who plates up food to reliably take out the food from the cooking container when the person plates up the food from the cooking container onto the plate.

According to the automated cooking method of the invention according to claim 6, there is provided a mechanism for detecting a pivot position of the stir member, the mechanism including a detection object provided to the stir member and a detector arranged in the exterior of the cooking container and configured to detect the detection object, so that the detector detects the detection object passing the detector, whereby the control unit determines a pivot position of the stir member, and thus, regardless of a configuration of engagement between the stir member and the container holding unit, it is possible to determine a pivot position when the stir member detachably attached to the container body and configured to rotate independently of the container body rotates relative to the container body.

Further, the automated cooking method comprises a pivot position determining step in which the control unit determines a pivot position of the stir member and a plating assist step in which after completion of the stirring cooking step, the cooking container is tilted forward to a plating assist posture, in which the stir member is configured such that in the plating assist posture, the tip of the stir member is at a retreat position farthest from a plate placed on the cooking counter, so that in the plating assist posture, the tip of the stir member is located upward, which can make it easier for a person who plates up food to reliably take out the food from the cooking container when the person plates up the food from the cooking container onto the plate.

### BRIEF DESCRIPTION OF DRAWINGS

FIG. 1 is a perspective view of an automated cooking device 10 according to a first embodiment of the present invention.

FIG. 2 is a system configuration diagram of the automated cooking device 10 as illustrated in FIG. 1.

FIG. 3 is a hardware configuration diagram of a control unit 800 as illustrated in FIG. 1

FIG. 4 is a left side view of the automated cooking device 10 as illustrated in FIG. 1.

FIG. 5 is a front view of a cooking container 300 when an ingredient is fed in the cooking container 300 as illustrated in FIG. 1.

FIG. 6 is a left side partial cross-sectional view of the automated cooking device 10 as illustrated in FIG. 1.

FIG. 7 is an enlarged view of VIII of FIG. 6.

FIG. 8 is a left side view of the automated cooking device 10 as illustrated in FIG. 1 in a plating assist posture.

FIG. 9 is a schematic diagram illustrating a pivot range of a stir member 320 in a washing posture.

### DESCRIPTION OF EMBODIMENTS

The present invention may be embodied in any way as long as an automated cooking device according to the present invention comprises: a cooking container including a bottomed cylindrical container body configured to contain an ingredient and a stir member detachably attached to the container body and configured to rotate independently of the container body; a container holding unit configured to allow the stir member of the cooking container to rotate, while holding the cooking container; and a control unit configured to control driving of the container holding unit, the automated cooking device being configured to stir and cook the ingredient contained in the cooking body using the stir member, in which the automated cooking device has a mechanism for detecting a pivot position of the stir member, the mechanism including a detection object provided to the stir member and a detector arranged in the exterior of the cooking container and configured to detect the detection object and being configured to determine a pivot position when the stir member detachably attached to the container body and configured to rotate independently of the container body rotates relative to the container body.

For example, the automated cooking device according to the present invention is to be installed mainly in a restaurant store, but an installation location of the automated cooking device according to the present invention is not limited to this and may include a food court, an office, a family house, etc.

For example, an ingredient cooked by the automated cooking device according to the present invention may be any food, such as rice, noodles, vegetables, fish, grains, and various seasonings.

For example, the automated cooking device according to the present embodiment may include a container heating unit configured to inductively heat the cooking container so as to heat and cook an ingredient contained in the cooking container, but may also merely stir and cook an ingredient contained in the cooking container without heating the same.

For example, in the automated cooking device according to this embodiment, it is preferable in view of maintenance and structural simplicity to connect the container holding unit and the stir member with each other by magnetic coupling so that the stir member can be detachably attached to the container body and the container holding unit allows the stir member to rotate, but any specific structure for detachably attaching the stir member to the container body may be employed as long as the stir member can rotate by the container holding unit without being influenced by the rotation of the container body when the container body rotates by the container holding unit.

For example, the detection object is detected by the detector preferably on the basis of magnetic detection, but optical detection using a laser, etc., detection based on an eddy current or the like may also be used.

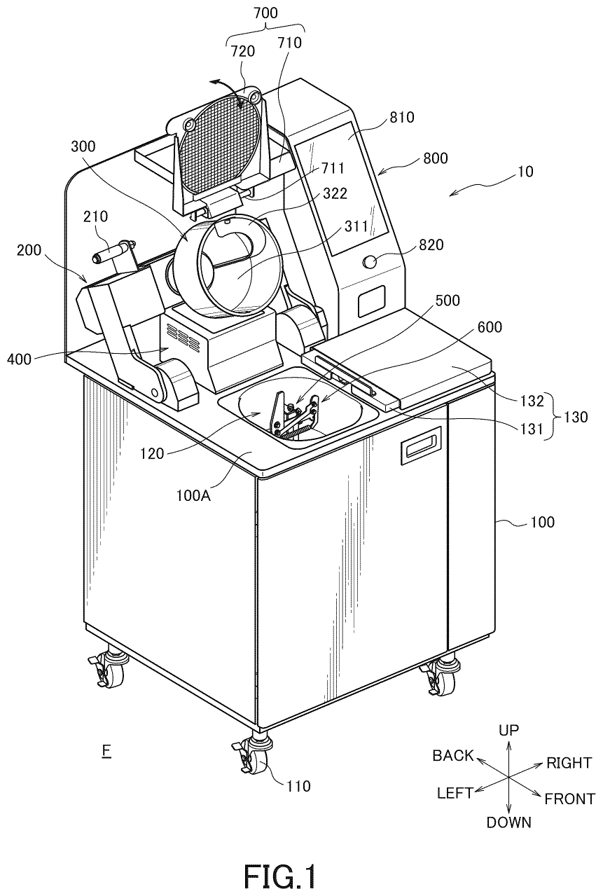

### Embodiment 1 In the following, an automated cooking device 10 according to a first embodiment of the present invention will be described with reference to FIG. 1 to FIG. 9.

### <1. Basic Configuration of Automated Cooking Device>

First, a basic configuration of the automated cooking device 10 will be described with reference to FIG. 1 to FIG. 4.

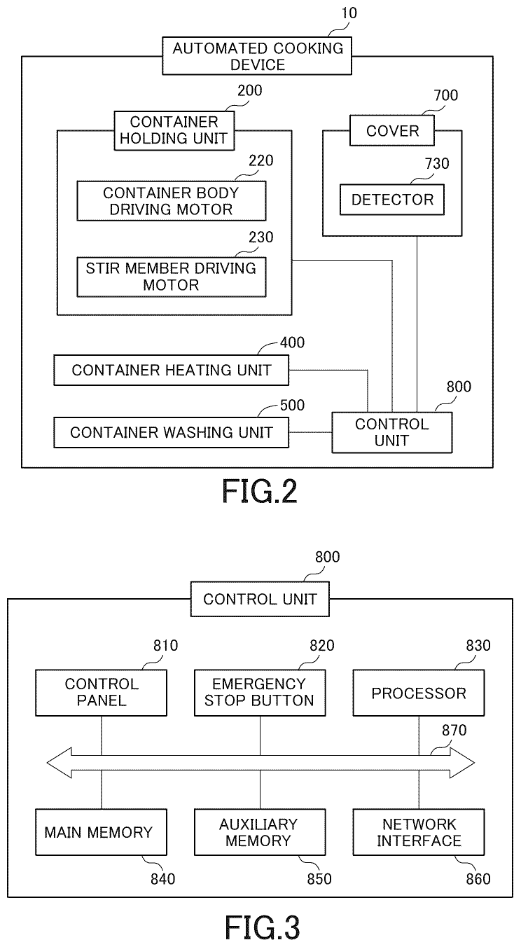

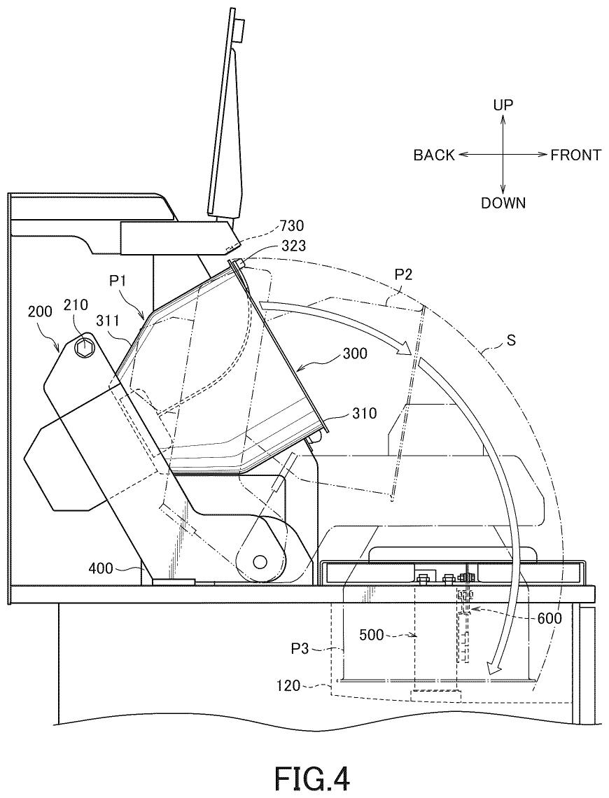

FIG. 1 is a perspective view of the automated cooking device 10 according to a first embodiment of the present invention, FIG. 2 is a system configuration diagram of the automated cooking device 10 as illustrated in FIG. 1, FIG. 3 is a hardware configuration diagram of a control unit 800 as illustrated in FIG. 1, and FIG. 4 is a left side view of the automated cooking device 10 as illustrated in FIG. 1.

Note that in FIG. 4, an ingredient is omitted.

First, as illustrated in FIG. 1, the automated cooking device 10 is movably provided on a floor surface F.

Then, the automated cooking device 10 includes a cooking counter 100 configured to serve as a base, a container holding unit 200 placed on the cooking counter 100, a cooking container 300 rotatably held by the container holding unit 200, a container heating unit 400 placed on the cooking counter 100 and configured to inductively heat the cooking container 300, a container washing unit 500 and a scraping unit 600 provided to the cooking counter 100, a cover 700 configured to allow an opening face of the cooking container 300 to be opened or closed, and a control unit 800 placed on the cooking counter 100 and configured to carry out integrated control of the entirety of the automated cooking device 10, and the automated cooking device 10 is configured to cook a food in an automated manner by stirring and cooking an ingredient contained in the cooking container 300.

The cooking counter 100 includes a plurality of casters 110 provided to a bottom surface thereof, a sink 120 formed in a front area of a top surface 100A, and a plate table 130 configured to allow the sink 120 to be opened or closed and on which a plate or the like is placed.

The plate table 130 includes: a board for plating 131 slidable in a left and right direction and configured to close an opening face of the sink 120 and on which a plate on which the stirred and cooked ingredient is to be plated up is placed; and a board storage member 132 configured to store the board for plating 131 and on which a plate or the like is to be temporarily placed.

The container holding unit 200 includes a handle 210 configured to be grasped by a user of the automated cooking apparatus 10, and as illustrated in FIG. 4, an operation of a user of the automated cooking apparatus 10 can cause the cooking container 300 to rise and fall in a front and back direction of the cooking counter 100.

Note that hereinafter a posture of the cooking container 300 in which the cooking container 300 and the container heating unit 400 are closest to each other as indicated by P1 will be referred to as a “cooking posture”, a posture of the cooking container 300 in which a side surface 311 of the cooking container 300 is tilted forward as indicated by P2 will be referred to as a “plating assist posture”, and a posture of the cooking container 300 placed in the sink 120 while the opening face of the cooking container 300 faces downward as indicated by P3 will be referred to as a “washing posture”.

Further, in the interior, the container holding unit 200 has a built-in posture holding member for maintaining a rise or fall posture of the container holding unit 200 and a built-in posture detecting sensor for detecting the cooking posture P1 and the washing posture P3.

The container heating unit 400 is placed on a back side of the sink 120 and configured to heat the side surface 311 of the cooking container 300 by inductive heating.

The container washing unit 500 is provided in the interior of the sink 120 and configured to discharge rinse water or the like onto the cooking container 300.

The scraping unit 600 is provided in the interior of the sink 120 and configured to remove a dirt, such as a burn adhering to the cooking container 300.

As illustrated in FIG. 1, the cover 700 has an arm 710 attached to the control unit 800 and a cover body 720 provided to the arm 710 and configured to be pivotable around a cover central axis 711 extending in the left and right direction.

A large part of the cover 700 is configured to have a mesh shape such that the interior of the cooking container 300 can be viewed while the opening face of the cooking container 300 is closed.

The control unit 800 includes a control panel 810 for operations and an emergency stop button 820 for carrying out an emergency stop of a cooking operation of the automated cooking device 10 and is configured to control driving of each unit based on an input to the control panel 810.

Further, as illustrated in FIG. 2, the control unit 800 is connected to the container holding unit 200, the container heating unit 400, the container washing unit 500, and the cover 700 and configured to control driving of such units and the like.

As illustrated in FIG. 3, the control unit 800 further includes at least a processor 830, a main memory 840, an auxiliary memory 850, and a network interface 860.

Each component constituting the control unit 800 is connected via a bus 870 which is a data transmission path between such components.

Note that the processor 830 is implemented as a CPU (Central Processing Unit) or a GPU (Graphics Processing Unit) and carries out various processing according to programs stored in the main memory or the auxiliary memory.

The main memory 840 is constituted by an SRAM (static RAM (Random Access Memory)), a DRAM (Dynamic RAM), a flash memory or the like and temporarily stores data required for calculation processing by the control unit 800.

The auxiliary memory 850 is implemented as an HDD (Hard Disk Drive, an SSD (Solid State Drive), a removable medium, such as a memory card, or a ROM (Read-Only Memory) and includes a recording medium.

The network interface 860 communicates with other terminals, systems or the like via a communication network including the internet.

### <2. Details of Cooking Container>

Next, details of the cooking container 300 will be described with reference to FIG. 1 and FIG. 4 to FIG. 7.

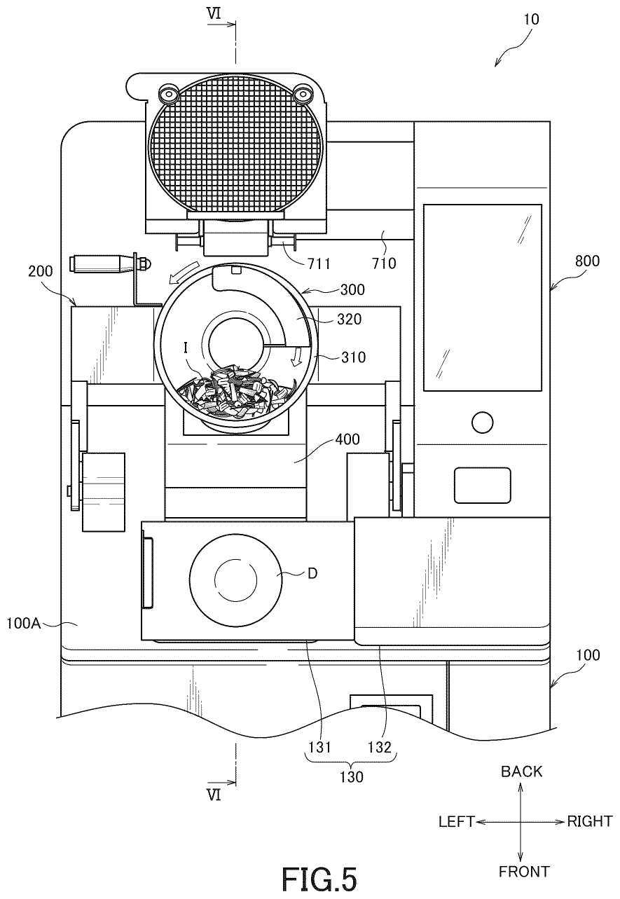

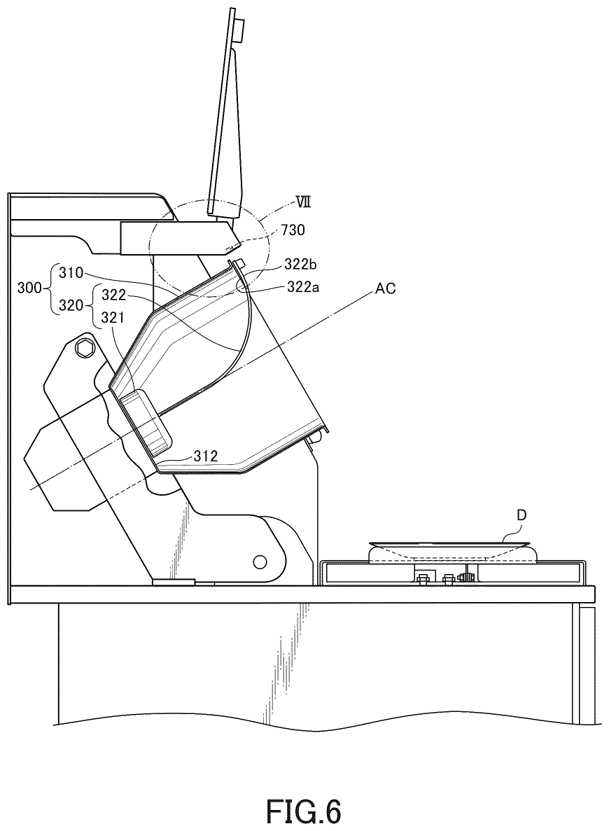

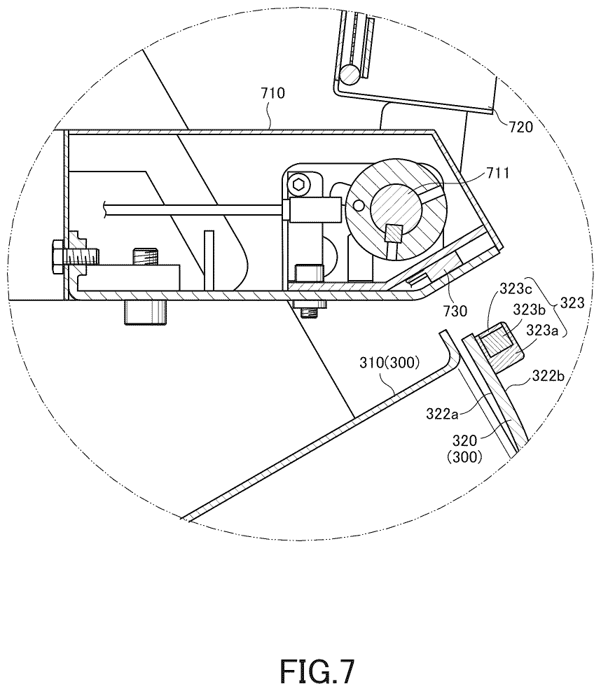

FIG. 5 is a front view of the cooking container 300 when an ingredient is fed in the cooking container 300 as illustrated in FIG. 1, FIG. 6 is a left side partial cross-sectional view of the automated cooking device 10 as illustrated in FIG. 1, and FIG. 7 is an enlarged view of VIII of FIG. 6.

Note that in FIG. 5, a plate D is placed on a board for plating 131 of a plate table 130, and in FIG. 6, an ingredient I is omitted.

The cooking container 300 is detachable from the container holding unit 200 and, as illustrated in FIG. 5, FIG. 6, etc., has a bottomed cylindrical container body 310 configured to contain the ingredient I and a stir member 320 detachably attached to a bottom portion of the container body 310 and configured to stir the ingredient I contained in the container body 310.

The container body 310 can rotate around a container body rotation axis AC extending in a depth direction of the container body 310 as illustrated in FIG. 6 using a power transmitted from a container body driving motor 220 (see FIG. 2) of the container holding unit 200.

The stir member 320 is provided with a magnetized ferromagnetic body on a bottom surface side thereof in such a manner as to form a magnet coupling mechanism by means of a magnetized ferromagnetic body provided at a tip of a stir member rotating shaft (unillustrated) of the container holding unit 200.

The stir member 320 is configured to be rotatable around the container body rotation axis AC using a power transmitted from a stir member driving motor 230 (see FIG. 2) of the container holding unit 200 via the magnet coupling mechanism and is configured to rotate independently of the container body 310.

Thus, the automated cooking device 10 according to this embodiment can allow the stir member 320 to rotate faster than the container body 310 or to rotate slower than the container body 310.

As illustrated in FIG. 6, the stir member 320 is formed of a cylindrical base portion 321 attached to the container body 310 and a spatula 322 attached to a side surface of the base portion 321.

The spatula 322 has such a shape that a flat plate is bent in a complex manner and, as illustrated in FIG. 5 and FIG. 7, has an inner surface 322a facing a bottom surface 312 of the container body 310 and an outer surface 322b on a side opposite to the inner surface 322a.

### <3. Pivot Position Detecting Mechanism of Stir Member 320>

According to the cooking container 300 as described above, the stir member 320 is not formed axially symmetrically with respect to the container body rotation axis AC, so that in order to realize trained skills of a stir operation by a cook in a more natural and advanced manner, the control unit 800 needs to detect and determine a pivot position of the stir member 320 and control rotation (pivot) of the stir member 320.

Further, the stir member 320 rotates independently of the container body 310, so that the control unit 800 cannot estimate a pivot position of the stir member 320 from a pivot position of the container body 310 and thus needs to directly detect a pivot position of the stir member 320.

In this regard, a pivot position detecting mechanism of the stir member 320 will be described with reference to FIG. 7, etc.

In the automated cooking device 10 according to this embodiment, as illustrated in FIG. 7, a detection object 323 is disposed on the outer surface 322b near the tip of the spatula 322 of the stir member 320.

The detection object 323 is composed of a rectangular parallelepiped case 323a attached to the spatula 322, a magnet 323b housed in the case 323a, and a protection lid 323c for protecting the magnet 323b.

As illustrated in FIG. 7, etc., a detector for detecting a magnetic force generated from the detection object 323 (magnet 323b) is provided as a magnetic sensor 730 built in an arm 710 of the cover 700.

As illustrated in FIG. 4, the magnetic sensor 730 is located outside of a range S of the cooking container 300, i.e., in the exterior of the cooking container 300 passing when a user of the automated cooking device 10 causes the cooking container 300 to rise and fall in the front and back direction of the cooking counter 100 (i.e., when a posture of the cooking container 300 is changed from the cooking posture P1 to a washing posture P3).

Further, as illustrated in FIG. 2, the magnetic sensor 730 is connected to the control unit 800 and configured to transmit various signals to the control unit 800.

Thus, the control unit 800 is configured to control each motor of the container holding unit 200, the container heating unit 400, etc. based on signals from the magnetic sensor 730.

### <4. Automated Cooking Method Using Automated Cooking Device 10>

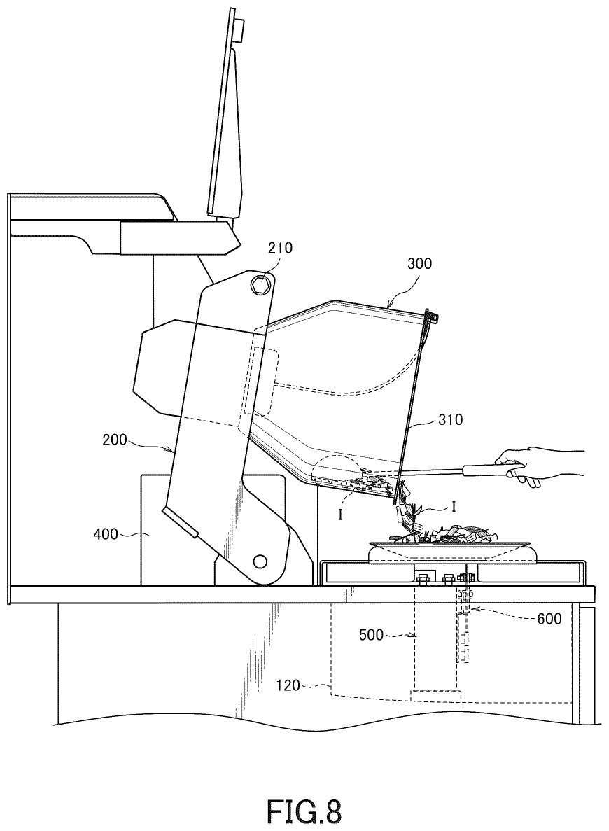

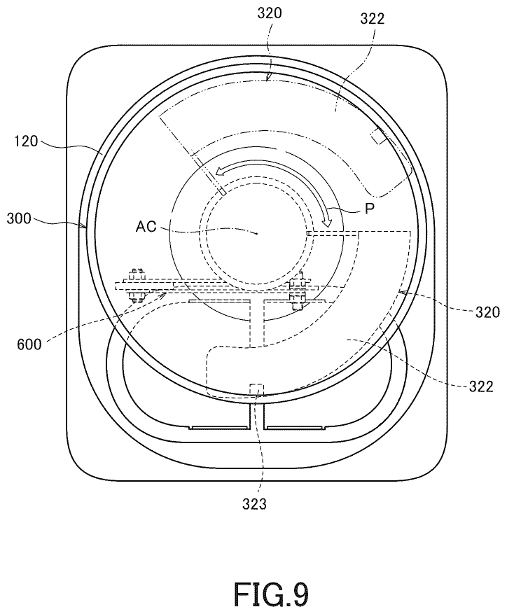

Next, an automated cooking method using the automated cooking device 10 according to this embodiment as described above will be described with reference to FIG. 4, FIG. 5, FIG. 8 and FIG. 9.

Then, each step will be described with reference to FIG. 4, FIG. 5, FIG. 8 and FIG. 9.

FIG. 8 is a left side view of the automated cooking device 10 as illustrated in FIG. 1 in a plating assist posture and FIG. 9 is a schematic diagram illustrating a pivot range of the stir member 320 in a washing posture.

### <Pivot Position Determining Step>

When the stir member 320 is attached to the container body 310 held in the container holding unit 200 of the automated cooking device 10, first, a pivot position determining step is carried out as an initial setting.

In a rotation position detecting step, while the posture detecting sensor of the container holding unit 200 detects that the cooking container 300 is in the cooking posture P1, the control unit 800 allows the stir member 320 to rotate using a power from the container holding unit 200.

Then, the control unit 800 stores that a rotation phase of the stir member driving motor 230 of the container holding unit 200 when the detection object 323 (i.e., the tip of the stir member 320) is closest to the detector 730 is a retreat position of the stir member 320 (a position of the stir member 320 at which the tip of the stir member 320 is at the top).

In other words, the pivot position determining step is a step in which the control unit 800 determines a pivot position of the stir member 320 using a rotation phase of the stir member driving motor 230 of the container holding unit 200.

The automated cooking method using the automated cooking device 10 according to this embodiment is carried out after the pivot position determining step is carried out.

Then, the automated cooking method is carried out in the following order: (1) a stirring cooking step, (2) a plating assist step, and (3) a container washing step.

### <4.1. Stirring Cooking Step>

In the stirring cooking step, the control unit 800 detects whether or not the cooking container 300 is in the cooking posture P1 as illustrated in FIG. 4 and FIG. 5. When the cooking container 300 is in the cooking posture P1, the control unit 800 controls the container heating unit 400 so as to inductively heat the cooking container 300, while controlling driving of the container holding unit 200 so as to rotate the container body 310 of the cooking container 300 and to rotate the stir member 320 independently of the container body 310, thereby stirring and heating the ingredient I.

A pivot control on the cooking container 300 (container body 310, stir member 320) by the container holding unit 200 and a heating control on the cooking container 300 by the container heating unit 400 are carried out based on a cooking program stored in the control unit 800 depending upon a dish to be cooked by the automated cooking device 10.

### <4.2. Plating Assist Step>

After completion of stirring and cooking of the ingredient I, the control unit 800 allows the stir member driving motor of the container holding unit 200 to pivot so as to rock the stir member 320 clockwise and counterclockwise several times, and then allows the stir member 320 to pivot to the retreat position.

While the stir member 320 has pivoted to the retreat position, a user of the automated cooking device 10 allows the container holding unit 200 to rotate forward using the handle 210 such that the cooking container 300 is tilted forward to the plating assist posture P2 as illustrated in FIG. 4 and FIG. 8.

A person who plates up the food, who may be the same as a user of the automated cooking device 10, takes out the food from the cooking container 300 assuming the plating assist posture P2.

Note that in the plating assist posture P2, as illustrated in FIG. 8, the stir member 320 is at the retreat position, so that the tip of the stir member 320 is farthest from the plate D placed on the board for plating 131 of the plate table 130.

In other words, there are provided the pivot position determining step in which the control unit 800 determines a pivot position of the stir member 320 and the plating assist step in which after completion of the stirring cooking step, the cooking container 300 is tilted forward from the cooking posture P1 to the plating assist posture P2, and, with respect to the stir member 320, in the plating assist posture P2, the tip of the stir member 320 is at the retreat position furthest from the plate D placed on the cooking counter 100, so that in the serving assist posture P2, the tip of the stir member 320 is positioned upward, which makes it easier for a person who plates up the food to reliably take out the food from the cooking container 300 when the person plates up the food from the cooking container 300 onto the plate.

### <4.3. Container Washing Step>

After the person who plates up the food takes out the food from the cooking container 300 assuming the plating assist posture P2, a user of the automated cooking device 10 allows the container holding unit 200 to rotate further forward using the handle 210 such that the cooking container 300 is tilted forward to the washing posture P3 as illustrated in FIG. 4.

Then, an inner surface of the container body 310 abuts against the scraping unit 600.

Subsequently, when the posture detecting sensor of the container holding unit 200 detects that the cooking container 300 is in the washing posture P3, the container holding unit 200 allows the container body 310 to rotate, while the container washing unit 500 discharges rinse water toward the container body 310.

Thus, a dirt adhering to the container body 310 can be removed.

Then, to reliably wash the stir member 320, the stir member 320 is rocked within such a safe pivot range P as illustrated in FIG. 9 that the stir member 320 does not interfere with the container washing unit 500 or the scraping unit 600 when the cooking container 300 is caused to rise from the washing posture P3.

Note that since in the plating assist posture P2, a pivot position of the stir member 320 is controlled such that the tip of the stir member 320 is positioned farthest from the plate D placed on the board for plating 131 of the plate table 130, then, in the washing posture P3 following the plating assist posture P2, the control unit 800 has determined a pivot position of the stir member 320.

Thus, the automated cooking device 10 according to this embodiment is capable of rocking the stir member 320 within the safe pivot range P by controlling driving using the control unit 800.

<5. Effects Produced by Automated cooking Device 10>

According to the automated cooking device 10 according to an embodiment of the present invention, the automated cooking device 10 has a mechanism for detecting a pivot position of the stir member 320, the mechanism including a detection object 323 provided to the stir member 320 and a detector 730 arranged in the exterior of the cooking container 300 and configured to detect the detection object 323, so that the detector 730 detects the detection object 323 passing the detector 730, whereby the control unit 800 determines a pivot position of the stir member 320, and thus, regardless of a configuration of engagement between the stir member 320 and the container holding unit 200, it is possible to determine a pivot position when the stir member 320 detachably attached to the container body rotates.

Further, the detection object 323 has a magnet 323b, and the detector is the magnetic sensor 730, so that the control unit 800 determines a pivot position of the stir member 320 on the basis of a change in the magnetic field around the detector. Thus, in comparison with a case in which the detector optically detects the detection object 323, not only it is possible to reliably determine a pivot position of the stir member 320 even if the detector or the detection object 323 is stained with a dirt due to cooking, such as a greasy dirt, but also there is no influence on a person who carries out a cooking assist operation or the like around the automated cooking device 10. In addition, in comparison with a case in which the detector is a proximity sensor configured to detect the detection object 323 on the basis of an eddy current, a detection performance can be ensured even if a relative distance between the detector and the stir member is large, so that the degree of freedom of a device design of the automated cooking device 10 can be improved.

Moreover, the magnetic sensor 730 is located outside of a range S of the cooking container 300 passing when the cooking container 300 is caused to rise and fall in the front and back direction of the cooking counter 100, so that the cooking container 300 does not interfere with the magnetic sensor 730 even if the container holding unit 200 allows the cooking container 300 to rise and fall in the front and back direction. Consequently, the container holding unit 200 allows the cooking container 300 to rise and fall in the front and back direction such that various postures can be easily assumed.

In addition, the detection object 323 is disposed on the outer surface 322b of the stir member 320, so that the ingredient I, seasonings or the like are less likely to adhere to the detection object 323 when the automated cooking device 10 stirs and cooks the ingredient I, and thus it is possible to prevent the detection object 323 from being stained with the ingredient I, etc.

### <Variants>

The automated cooking device according to some embodiments of the present invention has been described, but the automated cooking device according to the present invention is not limited to the automated cooking device 10 according to the above embodiments.

For example, any timing of control to allow the tip of the stir member to pivot to the retreat position farthest from the plate placed on the cooking counter may be employed as long as the tip of the stir member is at the retreat position farthest from the plate placed on the cooking counter when the cooking container is tilted forward to the plating assist posture.

For example, in this embodiment, washing of the cooking container 300 is started when the posture detecting sensor of the container holding unit 200 detects that the cooking container 300 is in the washing posture P3, but may also be started based on an input to the control panel 810 of the control unit 800.

### REFERENCE SIGNS LIST

10 automated cooking device
100 cooking counter
100A top surface
110 caster
120 sink
130 plate table
131 board for plating
132 board storage member
200 container holding unit
210 handle
220 container body driving motor
230 stir member driving motor
300 cooking container
311 side surface
312 bottom surface
320 stir member
321 base portion
322 spatula
322a inner surface
322b outer surface
323 detection object
323a case
323b magnet
323c protection lid
400 container heating unit
500 container washing unit
700 cover
710 arm
711 cover central axis
720 cover body
730 magnetic sensor (detector)
800 control unit
810 control panel
820 emergency stop button
830 processor
840 main memory
850 auxiliary memory
860 network interface
870 bus
F floor surface
I ingredient
D plate
AC container body central axis
P1 cooking posture
P2 plating assist posture
P3 washing posture
S cooking container passing range
P safe pivot range

1. An automated cooking device comprising: a cooking container including a bottomed cylindrical container body configured to contain an ingredient and a stir member detachably attached to the container body and configured to rotate independently of the container body; a container holding unit configured to allow the stir member of the cooking container to rotate, while holding the cooking container; and a control unit configured to control driving of the container holding unit, the automated cooking device being configured to stir and cook the ingredient contained in the cooking body using the stir member, characterized in that
the automated cooking device has a mechanism for detecting a pivot position of the stir member, the mechanism including a detection object provided to the stir member and a detector arranged in the exterior of the cooking container and configured to detect the detection object.

2. The automated cooking device according to claim 1, characterized in that the detection object has a magnet, and
the detector is a magnetic sensor.

3. The automated cooking device according to claim 1, characterized in that the container holding unit can cause the cooking container to rise and fall in a front and back direction of a cooking counter on which the container holding unit is placed, and
the detector is located outside of a range of the cooking container passing when the cooking container is caused to rise and fall in the front and back direction of the cooking counter.

4. The automated cooking device according to claim 1, characterized in that the stir member has an inner surface facing the container body and an outer surface on a side opposite to the inner surface, and
the detection object is disposed on the outer surface of the stir member.

5. The automated cooking device according to claim 1, characterized in that the container holding unit can cause the cooking container to rise and fall in a front and back direction of a cooking counter on which the container holding unit is placed,
the detection object is provided near a tip of the stir member, and
the control unit is configured to control driving of the container holding unit such that in a plating assist posture in which the cooking container is tilted forward, the tip of the stir member is located at a retreat position farthest from a plate placed on the cooking counter.

6. An automated cooking method using an automated cooking device, the automated cooking device comprising: a cooking container including a bottomed cylindrical container body configured to contain an ingredient and a stir member detachably attached to the container body and configured to rotate independently of the container body; a container holding unit capable of causing the cooking container to rise and fall in a front and back direction of a cooking counter and configured to allow the stir member of the cooking container to rotate, while holding the cooking container; a control unit configured to control driving of the container holding unit; and a mechanism for detecting a pivot position of the stir member, the mechanism including a detection object provided near a tip of the stir member and a detector arranged in the exterior of the cooking container and configured to detect the detection object, the automated cooking method comprising:
a pivot position determining step in which the control unit determines a pivot position of the stir member;
a stirring cooking step in which in a cooking posture in which the cooking container is tilted backward, the stir member of the cooking container is allowed to rotate to stir and cook the ingredient contained in the container body; and
a plating assist step in which after completion of the stirring cooking step, the cooking container is tilted forward to a plating assist posture, characterized in that
the stir member is configured such that in the plating assist posture, the tip of the stir member is at a retreat position farthest from a plate placed on the cooking counter.
